(19) United States
(12) Patent Application Publication
(10) Pub. No.: US 2011/0036095 A1
(43) Pub. Date: Feb. 17, 2011

(54) THERMAL VAPOR STREAM APPARATUS AND METHOD

(75) Inventor: Richard W. Krajicek, Houston, TX (US)

Correspondence Address: LOCKE LORD BISSELL & LIDDELL LLP, 600 TRAVIS SUITE 2800, HOUSTON, TX, 77002-3095, US

(73) Assignee: ZERO-CO2 LLC, Wilmington, DE (US)

(21) Appl. No.: 12/539,205

(22) Filed: Aug. 11, 2009

(51) Int. Cl. F02C 3/30; F22B 27/16; E21B 43/24

(52) U.S. Cl. 60/775; 110/234; 122/40; 60/39.55; 166/369

(57) ABSTRACT

A low emission and environmentally friendly apparatus and method is used to generate a high pressure stream of thermal vapor. The thermal vapor stream may be injected into a subterranean formation for recovery of highly viscous petroleum or used to turn a steam turbine for driving an electrical generator. In one implementation, the high pressure stream of thermal vapor is generated by burning a high temperature fuel, including any short or long chain hydrocarbon products from methane to coal, in an enclosed vessel to produce combustion gases. Various techniques may be used to improve heat distribution and lower the temperature of the combustion gases. Water may be used to quench the combustion gases and produce the superheated steam or vapor. The water may be introduced onto the combustion gases by spraying, weeping, dripping, and the like.

### CROSS REFERENCE TO RELATED APPLICATIONS

Not Applicable

### TECHNICAL FIELD OF THE INVENTION

Aspects of the invention relate generally to the use of a thermal vapor stream for cogeneration of electricity and heat and desirable gases, and for recovery of petroleum from a subterranean formation. More particularly, aspects of the invention relate to new and improved apparatuses and methods for producing a high pressure thermal vapor stream that may be injected into the subterranean formation for recovering heavy viscous petroleum, or for sequestering the gases of combustion while producing electricity.

### BACKGROUND OF THE INVENTION

Successful recovery of highly viscous petroleum using a high pressure thermal vapor stream typically involves production of hot combustion gases that are flowed into a steam generating device to produce large quantities of high pressure thermal vapor or steam. The high pressure thermal vapor or steam is thereafter injected into a subsurface formation to facilitate extraction of the highly viscous petroleum therefrom. This recovery process is commonly referred to by those having ordinary skill in the art as “huff and puff.” Examples of apparatuses that may be used to produce a high pressure thermal vapor stream are described in U.S. Pat. Nos. 4,156,421; 4,118,925; 3,980,137; 3,620,571; 2,916,877; 2,839,141; 2,793,497; 2,823,752; 2,734,578; 2,754,098; and 4,398,604; as well as Mexican Patents Nos. 105,472 and 106,801. Additionally, various methods for using such apparatuses are known in the art and include processes such as those disclosed in U.S. Pat. Nos. 3,993,135 and 3,948,323.

It is well known that in order to provide economical recovery of highly viscous petroleum, large volumes of thermal vapor must be generated and injected into the formation. This is particularly true, for example, where the thermal vapor is injected into the subsurface formation continuously over several hours, days, weeks, or even months. In addition, the thermal vapor must also be injected into the subsurface formation under pressures higher than the formation pressure in order for the thermal vapor to penetrate the formation. Moreover, certain highly viscous hydrocarbon deposits also require the application of large amounts of heat to reduce the viscosity and thus make recovery possible.

Because of the high volumes, pressures, and temperatures involved, difficulties often arise in obtaining, operating and maintaining the equipment and apparatuses needed for generating the required amounts of combustion gases that will produce the required amounts of steam under sufficiently high pressures and temperatures to provide satisfactory economic recovery of the highly viscous petroleum. For example, existing apparatuses that are capable of generating a suitable high pressure thermal vapor stream tend to be large, heavy, and complex, and typically emit gases that are not very environmentally-friendly, all of which may result in additional costs to the petroleum recovery process. The environmentally harmful emissions of conventional equipment also make it difficult to use the high pressure thermal vapor stream for other applications, such as cogeneration of electricity and heat.

Accordingly, what is needed is an improved apparatus and method for producing a high pressure thermal vapor stream for injection into a subsurface formation to facilitate recovery of heavy viscous petroleum, for cogeneration of electricity and heat, and the like.

### SUMMARY OF THE INVENTION

Aspect of the invention relate to a low emission and environmentally friendly apparatus and method for generating a high pressure thermal vapor stream. Such an apparatus and method may be used for recovering highly viscous petroleum from a subterranean formation, cogeneration of electricity and heat, and the like. The apparatus and method of the invention facilitate injection of a high pressure stream of thermal vapor comprising superheated steam, carbon dioxide, and nitrogen. In a subterranean formation, the high pressure thermal vapor stream may be used to enhance recovery of viscous petroleum. The superheated steam increases the transfer of latent heat throughout the formation, the carbon dioxide forms a miscible interface with the hydrocarbon in the petroleum and also reduces the viscosity of the petroleum, while the nitrogen migrates into the formation to create a gas drive for the petroleum. Solvents and other surfactants may also be added to the superheated steam to increase recovery of the petroleum from the formation.

The high pressure stream of thermal vapor may be generated by burning a high temperature fuel, such as diesel, crude oil, diesel-crude mixture, kerogen, coal powder, and other short and long chain hydrocarbon products in an enclosed jet vapor system. The fuel is preferably atomized such that it is in the form of a fine mist for improved combustion.

A removable, preformed refractory composed of multiple sections may be provided in some embodiments on the interior of the jet vapor system to help withstand the temperature in the jet vapor system. The refractory sections may have different thicknesses that create turbulence in the combustion gases to improve heat distribution in the jet vapor system. Because the high temperatures involved can limit the life of the refractory, in some embodiments, the refractory may be in the form of a unitary cartridge that may be easily and frequently removed from the jet vapor system and replaced as needed.

A cone or curtain of water may be formed around the flame produced by the combustion of the high temperature fuel in some embodiments to help lower the temperature of the refractory without lowering the temperature of the flame.

Water may then be introduced directly onto the combustion gases to create superheated steam or vapor. Various ways may be used to introduce the water onto the combustion gases, including spraying, weeping, dripping, and the like. A high temperature catalytic converter may be used to minimize emissions from the combustion process, and various corrosion-controlling chemicals may be added to the water to facilitate removal of any sulfur oxides or nitrogen oxides.

The high pressure thermal vapor stream may then be injected into the subterranean formation for enhanced recovery of heavy, viscous petroleum. Other applications for the high pressure thermal vapor stream may involve using the thermal vapor stream to turn a steam turbine for driving an electrical generator or as an energy source for any suitable equipment, and the like.

### BRIEF DESCRIPTION OF THE DRAWINGS

The foregoing and other advantages of the invention will become apparent from the following detailed description and upon reference to the drawings, wherein:

FIG. 1 illustrates an exemplary jet vapor system that may be used for generating a high pressure thermal vapor stream according to aspects of the invention;

FIG. 2 illustrates the exemplary jet vapor system in more detail according to aspects of the invention;

FIGS. 3A and 3B illustrate an exemplary head section of the jet vapor system according to aspects of the invention;

FIGS. 4A and 4B illustrate an exemplary combustion section of the jet vapor system according to aspects of the invention;

FIG. 5 illustrates exemplary refractory sections of the jet vapor system according to aspects of the invention;

FIGS. 6A and 6B illustrate an exemplary quench section of the exemplary jet vapor system according to aspects of the invention; and

FIG. 7 illustrates an exemplary method that may be used for generating a high pressure thermal vapor stream according to aspects of the invention.

### DETAILED DESCRIPTION OF EXEMPLARY EMBODIMENTS

The drawings described above and the written description of specific structures and functions below are not presented to limit the scope of what has been invented or the scope of the appended claims. Nor are the drawings drawn to any particular scale or fabrication standards, or intended to serve as blueprints, manufacturing parts list, and the like. Rather, the drawings and written description are provided to teach any person skilled in the art to make and use the inventions for which patent protection is sought. Those skilled in the art will appreciate that not all features of a commercial embodiment of the inventions are described or shown for the sake of clarity and understanding.

Persons of skill in this art will also appreciate that the development of an actual commercial embodiment incorporating aspects of the inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention or the appended claims.

As mentioned above, aspects of the invention are directed to a new and improved apparatus and method for producing a high pressure thermal vapor stream. The high pressure thermal vapor stream may then be used in a variety of applications, including injection into a subterranean formation to facilitate recovery of heavy viscous petroleum. Aspects of the invention are particularly useful for economically and efficiently recovering heavy viscous petroleum having API gravities of less than about 116 degrees and viscosities greater than about 150 centipoises (at 60 degrees Fahrenheit). Those having ordinary skill in the art will understand, however, that the inventive aspects described herein may be used to recover substantially any type of petroleum from substantially any type of subsurface petroleum-bearing formation. For example, aspects of the invention are also especially useful for recovering highly viscous petroleum from formations that have such low relative permeabilities to water and oil that they do not accept direct steam injection at pressures below formation fracture gradient pressures and high formation injection rates. These subterranean formations usually have an absolute permeability to air averaging in the range of about 50 to about 2000 millidarcy, but their relative permeabilities to water and oil may be less than one percent of the absolute permeability.

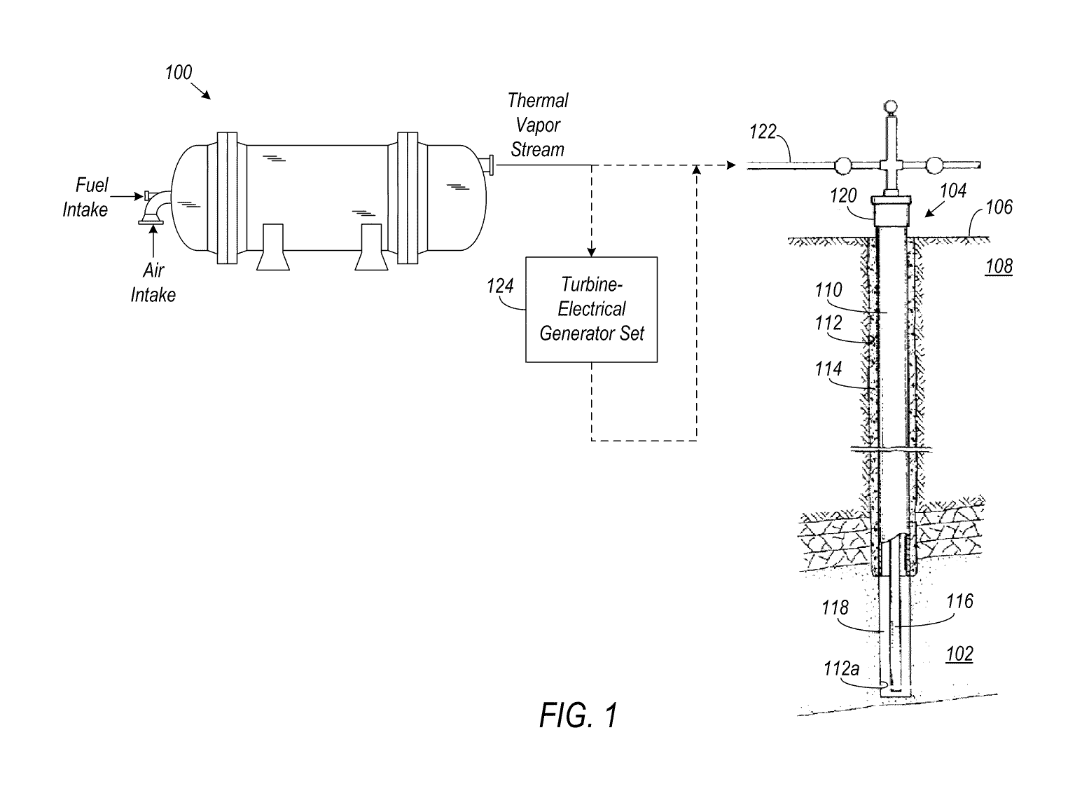

Referring now to FIG. 1, a jet vapor system 100 is shown that may be used to generate a high pressure thermal vapor stream according to aspects of the invention. The high pressure thermal vapor stream may then be used in various applications where such streams are useful, including enhanced oil recovery. In the example of FIG. 1, the high pressure thermal vapor stream is injected into a subterranean formation 102 to facilitate recovery of heavy viscous petroleum. Specifically, the high pressure thermal vapor stream is injected into a well 104 drilled through the surface 106 of the earth 108 and into the subterranean formation 102. The well 104 preferably has been completed in a conventional manner, which may include a string of casing 110 extending to the top of the subterranean formation 102 that is set within a bore hole 112 and supported by a high temperature cement sheath 114.

Preferably, the bore hole 112 penetrates to near the bottom of the desired formation injection zone in the subterranean formation 102. The bore hole 112 may be left open, as in an open hole completion, or it may have a screen slotted liner or other perforated device (not shown) set in the lower end 112a of the bore hole 112 to support the walls of the bore hole 112. The well 104 may also include a string of tubing 116 disposed within the casing 110, with the bore hole 112 extending through the formation 102 to thereby form an annulus 118 therebetween. In preferred implementations, the string of tubing 116 extends downwardly to near the lower end 112a of the bore hole 112.

A well head 120 and conventional sealing device (not shown) is provided adjacent the top of the well 104 to seal off the annulus 118 and maintain pressure within the well 104. The jet vapor system 100 may then be connected to the well head 120 by a flow line 122 to provide a high pressure thermal vapor stream for recovering the heavy viscous petroleum from the subterranean formation 102. In some implementations, the high pressure thermal vapor stream may be provided to a gas turbine-electrical generator set 124 for cogeneration of electricity and heating fuel, water, and/or other material as needed. Thermal vapor from the gas turbine-electrical generator set 124 may then be provided to the flow line 122 for injection into the subterranean formation 102.

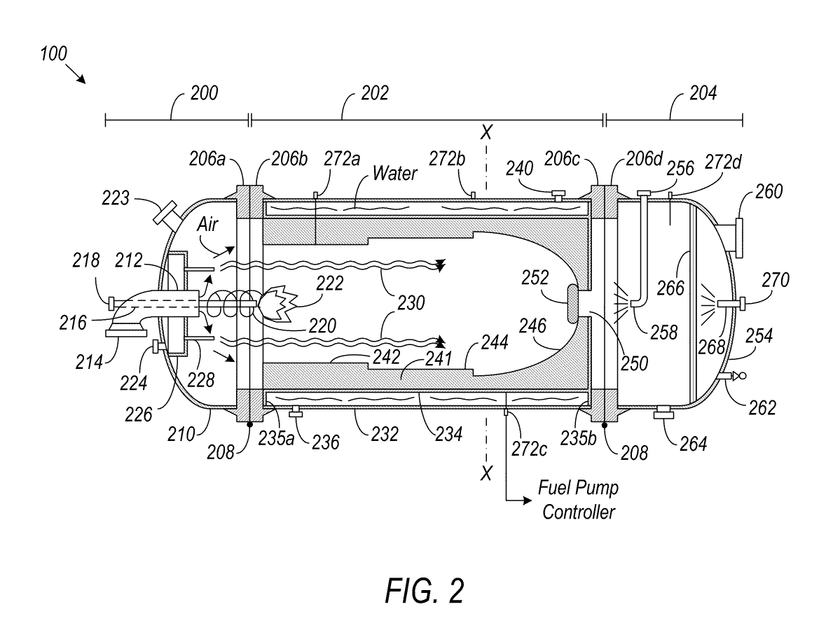

FIG. 2 shows the jet vapor system 100 in more detail according to aspects of the invention. As can be seen, the jet vapor system 100 has three generally tubular sections, namely, an intake section 200, a combustion section 202, and a quench section 204. These vessel sections 200-204, when coaxially connected as shown in FIG. 2, form an enclosed vessel of approximately six to eight feet (and preferably about seven feet) in outer length and approximately 20 to 40 inches (and preferably about 30 inches) in outer diameter. Those having ordinary skill in the art will understand, however, that other dimensions besides the particular ones mentioned here may be used for the jet vapor system 100 without departing from the scope of the disclosed embodiments.

In some embodiments, flanges 206a, 206b, 206c, 206d or similar mating component may be formed or otherwise attached (e.g., welded) to the openings in the vessel sections 200-204 for allowing the vessel sections 200-204 to be connected (i.e., bolted, riveted, etc.) to one another. The flanges 206a-d may be made of a material that is strong enough to withstand the high pressures inside the jet vapor system 100 as well as provide a watertight and airtight seal. An example of a flange that may be used is an ANSI (American National Standards Institute) Class 300 raised face weld neck flange made of a carbon or stainless steel material and complying with ASME (American Society of Mechanical Engineers) Standard SA-105. A gasket (not expressly shown) may also be used in conjunction with the flanges 206a-d to help achieve watertight and airtight sealing in some embodiments. One or more hinges 208 may also be provided for joining adjacent ones of the flanges 206a-d on some or all of the vessel sections 200-204 in some implementations to allow the intake and quench sections 200 and 204 to swing open, for example, for maintenance and repair of the jet vapor system 100.

Referring still to FIG. 2, each of the various vessel sections 200-204 will now be described in more detail. The intake section 200, as the name implies, acts as an intake for the jet vapor system 100, taking in air, fuel, and water, and the like. In some implementations, the intake section 200 may be made of a hemispherical or bowl shaped head 210, although an intake head 210 having a flat or even exterior may also be used in some embodiments. Where a curved intake head 210 is used, the intake head 210 may have a major-to-minor axis ratio of, for example, approximately 2:1, 2.5:1, 2:1.5, and the like. In any case, the intake head 210 should be made of a carbon or stainless steel material that satisfies, for example, ASME Standard SA-516-70 or similar standards. Such an intake head 210 may have a nominal thickness of approximately 0.5 to 1 inches and preferably about 0.625 inches, but other thicknesses may certainly be used as appropriate for the particular application.

An air line 212 may be provided in the intake head 210 extending into and stopping generally at the center of the intake head 210 for taking in air from an external air supply (not expressly shown) into the jet vapor system 100. The air line 212 may be a straight section of pipe in some embodiments, or it may be curved so that the portion of the air line 212 external to the jet vapor system 100 resembles a pipe elbow. An air intake 214 may then be attached to the air line 212 for coupling it to an air nozzle or similar air supply connector. The specific structure and operation of the air line 212 and air intake 214 are well known to those having ordinary skill in the art and will therefore not be described in detail here. Pressurized air from the external air supply may then be flowed into the jet vapor system 100 through the air line 212. The air may thereafter be used to burn a high temperature fuel, including any short or long chain hydrocarbon products, from methane to coal, in the jet vapor system 100.

Fuel may be provided from an external fuel supply (not expressly shown) via a fuel line 216 in the intake head 210. Such fuel may be provided at a rate of one gallon per minute, for example, and is preferably atomized using standard techniques into a fine mist for improved combustion. The fuel line 216 may extend through the intake head 210 and end just inside the combustion section 202. The fuel line 216 may be disposed within and preferably coaxial with the air line 212 to facilitate mixing of the fuel and air together within the vapor vessel 100. A fuel intake 218 may be attached to the fuel line 216 in order to couple the fuel line 216 to a fuel nozzle or similar fuel supply connector. In the specific embodiment of FIG. 2, the fuel intake 218 protrudes from the air line 212 at the curved portion thereof so that neither intake obstructs operation of the other intake, but alternative intake arrangements may of course be employed by those having ordinary skill in the art.

It is also possible to rotate or swirl the air passing through the air line 212 in some embodiments using, for example, vanes (not expressly shown) provided on the interior of the air line 212. The vanes help create turbulence 220 to thereby improve the mixing of the fuel and air in order to achieve more complete combustion, indicated generally by a flame 222. More complete combustion may also be accomplished by adding a small amount of water to the fuel, for example, approximately two to eight percent and preferably about five percent water. The water instantly and violently evaporates upon contact with the flame 222, resulting in a more complete combustion (but also lowering the temperature of the flame 222). An igniter port 223 may be installed on the intake head 210 at about a 45 degree angle to allow an operator to ignite the flame 222.

Finally, a water intake 224 may also be provided on the intake head 210 for taking in water from an external water supply (not expressly shown) into the jet vapor system 100. The water intake 224, similar to the air intake 214 and the fuel intake 218, may be designed for coupling to a water nozzle or similar water supply connector in a manner known to those having ordinary skill in the art. Water under pressure from the external water supply is received through the water intake 224 into an intake manifold 226 mounted on the interior of the intake head 210. The intake manifold 226, in some embodiments, may be two to three inches deep with a 12 to 15 inch outer diameter and made of an ASME Standard SA-53 carbon or stainless steel material that is welded to the intake head 210.

Water enters the intake manifold 226 at a rate of, for example, 20 gallons per minute, and is forced through a plurality of water nozzles 228 protruding from the intake manifold 226 towards the combustion section 202. The water nozzles 228, which may extend anywhere from just barely beyond the intake manifold 226 to all the way into the combustion section 202, spray jets of water 230 into the combustion section 202 that form a sort of water cone or curtain substantially surrounding the flame 222. The jets of water 230 serve as a heat barrier to lower the temperature around the flame 222 (without cooling the flame temperature) to thereby prevent the structural material of the jet vapor system 100, and particularly the combustion section 202, from exceeding certain temperature thresholds.

With respect to the combustion section 202, this is the section of the jet vapor system 100 where combustion of the fuel and air taken in by the intake section 200 may take place to produce combustion gases. As such, the temperature within the combustion section 202 can become extremely hot, depending on the type of fuel used. For example, a temperature of 3,500 to 4,000 degrees Fahrenheit may be reached when performing a stoichiometric burn of certain types of hydrocarbon products. It is therefore important for safety and other reasons to ensure that the enormous amount of heat generated in the combustion section 202 does not compromise the structural integrity of the jet vapor system 100.

With reference again to FIG. 2, the combustion section 202 may be composed of a combustion housing 232 that resembles a section of pipe (e.g., an ANSI Schedule 80 pipe) or hollow cylinder in some embodiments. The combustion housing 232 basically operates as a combustion chamber and may be made of the same or a similar carbon or stainless steel material as the intake head 210 described above. This combustion housing 232 may also have approximately the same outer diameter and thickness as the intake head 210, and may be approximately three to five feet or longer, and preferably about four feet long. Of course, other types of materials, dimensions, shapes, and the like may be used for the combustion housing 232 by those having ordinary skill in the art based on the requirements of a particular application without departing from the scope of the disclosed embodiments.

A coolant manifold 234 may be provided on the inner surface of the combustion housing 232 for cooling purposes. Like the combustion housing 232, the coolant manifold 234 may be an approximately three to five feet or longer (and preferably about four feet) section of pipe or hollow cylinder made of a similar carbon or stainless steel material, but with flanges 235a and 235b formed or otherwise attached to the ends thereof. The flanges 235a and 235b may have an outer diameter that allows them to fit flush inside and coaxially with the combustion housing 232, leaving an annular space of about two to three inches between the combustion housing 232 and the coolant manifold 234. A cooling fluid, such as water, may then be pumped from an external coolant supply (not expressly shown) through one or more coolant inlets 236 provided on the combustion housing 232 to fill the annular space with coolant (see wavy lines). The coolant helps keep the temperature on the combustion housing 232 from exceeding certain predefined thresholds. One or more coolant outlets 240 may be provided on the combustion housing 232 to allow the coolant in the annular space formed by the combustion housing 232 and the coolant manifold 234 to exit and be circulated.

In some embodiments, as a safety measure, the coolant manifold 234 may have a smaller thickness and/or may be made of a weaker material than the combustion housing 232. As a result, the structural integrity of the coolant manifold 234 may be compromised first, causing the coolant manifold 234 to fail before failure of the combustion housing 232, in the event of an unexpected temperature spike. This allows the coolant being retained by the coolant manifold 234 to escape into the interior of the combustion housing 232 and thereby snuff or extinguish the flame 222 before the structural integrity of the combustion housing 232, and hence the jet vapor system 100, can be compromised.

In addition to the coolant manifold 234, a refractory 241 having one or more refractory sections 242, 244, and 246 may be provided in the combustion housing 232 to help withstand the high temperatures in the combustion section 202. In some embodiments, the refractory 241 may be a kiln-dried refractory casted as a single unitary cartridge, although it is also possible to use three discrete and separately removable sections 242-246 for the refractory 241. Examples of a suitable refractory 241 may be obtained from Diamond Refractory Services and Huber Construction Company, both of Houston, Tex., as well as other refractory vendors. Materials that may be used for constructing a suitable refractory 241 may be obtained from Able Refractory Products, also of Houston, Tex.

Although three refractory sections 242-246 are shown in FIG. 2, it is possible to use a single section, two sections, or more than three refractory sections in some implementations. Any suitable refractory material known to those having ordinary skill in the art may be used for the refractory sections, including alumina, silica, and magnesia. By way of an example, a refractory material containing approximately 60 percent alumina, 30 percent silica, and 10 percent inert other ingredients has been found to be effective in some embodiments. But instead of laying pre-sintered bricks of refractory material to build the refractory 241, or spraying a refractory material on the coolant manifold 234 that must then be sintered, the refractory 241 (or each refractory section 242-246) is preferably precast as a discrete, unitary component that is ready to be used and may be handled as a single piece. This allows the refractory 241 (or each refractory section 242-246) to be more easily installed in and removed from the combustion section 202 as needed, for example, when performing maintenance and repair on the jet vapor system 100.

The refractory 241 may be generally tubular in shape and each refractory section 242-246 may have an outer diameter that allows the refractory 241 to fit in the combustion section 202 coaxially within the coolant manifold 234. This results in the refractory 241 having an outer diameter of approximately 23 to 25 inches (and preferably about 24 inches) in some embodiments. A small annular gap (about 1/16 inch, not expressly shown) may be provided between the refractory 241 and the coolant manifold 234 in some embodiments to allow air from the air line 214 to enter and flow in between the coolant manifold 234 and the refractory sections 242-246. This air flow in the small annular gap helps balance against the pressure exerted on the other side of the refractory 241 from the combustion gases flowing through the interior of the combustion section 202.

The use of the refractory 241 within the jet vapor system 100 is intended to lower the temperature in the combustion section 202 from between 3,000 to 3,400 degrees Fahrenheit, which is the maximum temperature that currently available refractory materials can withstand, to about 600 degrees Fahrenheit at or near the inner surface of the coolant manifold 234. According to some estimates, a minimum refractory thickness of about four inches is needed to accomplish the above temperature reduction. Thus, in most embodiments, each of the refractory sections 242-246 (assuming more than one refractory section) is at least four inches thick. Note that the temperature at or near the flame 222 may actually be higher than the refractory limit of 3,400 degrees Fahrenheit for certain fuels, but the jets of water 230 from the water nozzles 228 are expected to bring this temperature down to about 3,400 degrees Fahrenheit (or less) at or near the interior surface of the refractory sections 242-246 (without lowering the temperature of the flame 222).

In accordance with aspects of the invention, one or more of the refractory sections 242-246 may have a thickness that is different than another one of the refractory sections 242-246. For example, following in the direction of flow of the combustion gases (i.e., left to right), each refractory section 242-246 may have a smaller thickness than the immediately preceding refractory section 242-246, resulting in a larger opening at each refractory section 242-246. In one implementation, the first refractory section 242 may have a thickness of about six inches, whereas the next refractory section 244 may have a thickness of about five inches, and so on. Each stepwise decrease in refractory thickness has the effect of suddenly decreasing the velocity of the combustion gases flowing through that refractory section 242-246 relative to the preceding refractory section 242-246. The sudden drop in velocity, in turn, creates or increases turbulence in the combustion gases that causes heat to be more evenly distributed throughout the combustion section 202.

In some embodiments, the last refractory section 246 that the combustion gases flow through before entering the quench section 204 may serve as a sort of nozzle to funnel the combustion gases toward the quench section 204. To this end, the refractory section 246 may have a thickness that is smaller at one end and increases going towards the other end (the end adjacent to the quench section 204). By way of an example, the refractory section 246 may have a thickness of about four inches at the end furthest away from the quench section 204, and this thickness may increase to about nine inches at the end closest to the quench section 204. The increase in thickness may be a linear increase (resulting in a cone shaped nozzle), or it may be an exponential increase (resulting in a bowl shaped nozzle) similar to the one shown in FIG. 2. In either case, the increased thickness leaves only a small passageway 250 of about five to seven inches in diameter (and preferably about six inches) in the refractory section 246 for the combustion gases to flow through to the quench section 204 (hence, creating a funnel effect).

In some embodiments, the flange 235b of the cooling manifold 234 (i.e., the one adjacent to the quench section 204) may extend radially inward a suitable distance to provide backing support for the refractory 241. A mesh-type high temperature catalytic converter 252 may be removably disposed (e.g., via hooks, etc.) over the passageway 250 to convert or reduce any unwanted emissions (e.g., turn carbon monoxide to carbon dioxide, etc.) that may result from incomplete combustion of the fuel and air before the combustion gases enter the quench section 204.

The quench section 204, like the intake section 200, may include a head 254 that is similar in material and dimensions to the intake head 210 except that it may be longer (e.g., two to three feet in length). This quench head 254 may have a quench intake 256 for taking in water from an external water supply (not expressly shown) to quench the combustion gases. Such a quench intake 256 may be designed to couple with a water nozzle or similar water supply connector in a manner known to those having ordinary skill in the art. Water under pressure from the external water supply flows into the quench intake 256 through a water line 258 that introduces (e.g., by spraying) the water directly into the passageway 250 to quench any combustion gases entering the quench section 204. The water may be sprayed fairly evenly in a round or circular pattern that may extend approximately two or more inches around the circumference of the passageway 250. The introduction of the water onto the combustion gases heats the water into superheated steam or vapor (e.g., about 600 to 750 degrees Fahrenheit).

In some embodiments, the quench intake 256 and the water intake 224 may be connected to or otherwise be in fluid communication with each other and/or to the same external water supply. Indeed, where the coolant used in the coolant manifold 234 is water, the coolant inlet 236 may also be connected to or otherwise in fluid communication with water intake 224, the quench intake 256, and/or the same external water supply. In some embodiments, certain chemicals well known to those having ordinary skill in the art may be added to the water supply to convert any unwanted gases into a soluble substance that may subsequently be removed.

A vapor outlet 260 provided on the quench head 254 allows the superheated steam or vapor to exit the jet vapor system 100. The vapor outlet 260 may then be connected to the flow line 122 (see FIG. 1) for carrying the superheated steam or vapor into the subterranean formation 102, or to the gas turbine-electrical generators sent 124 cogeneration of heat and electricity. In some embodiments, a relief valve 262 may be provided in the quench head 254 to release excess pressure from the jet vapor system 100. A drain 264 may also be provided in the quench head 254 for removing any solids or particulates that collect on the bottom of the quench head 254. Finally, where coal powder or a similar combustion material is used as fuel, a filter 266 may be removably mounted in front of the vapor outlet 260 to capture any fly ash that may be present as a result of burning the coal powder or similar combustion material. In these embodiments, a backflush nozzle 268 may be provided to back spray water from a water intake 270 onto the filter 266 in order to flush or wash the fly ash from the filter 266. The backflushed fly ash may then be periodically collected and removed via the drain 264 as needed.

In some embodiments, a plurality of thermocouples or other temperature sensing devices may be provided at various locations on the jet vapor system 100 for monitoring and regulating the temperature throughout the jet vapor system 100 as needed. For example, a thermocouple 272a may be provided on the combustion housing 232 and configured for sensing the temperature on the refractory 241. Another thermocouple 272b may be provided on the combustion housing 232 and configured for sensing the temperature on the combustion housing 232 itself. Yet another thermocouple 272c may be provided on the combustion housing 232 and configured for sensing the temperature on the coolant manifold 234. Still another thermocouple 272d may be provided on the quench head 254 and configured for sensing the temperature on or inside the quench head 254. The output of these thermocouples 272a-d may be fed to various temperature-based monitoring devices for monitoring and regulating the temperature throughout the get vapor system 100 as needed. In one implementation, the output of the thermocouple 272c for the coolant manifold 234 may be connected to a fuel pump control unit that is configured to shut off fuel to the intake section 200 if the temperature on the coolant manifold 234 exceeds a certain predefined threshold (e.g., 600 degrees Fahrenheit). In another implementation, the output of the thermocouple 272d on the quench head 254 may be connected to a water pump control unit (not expressly shown) that is configured to increase the amount water sprayed on the combustion gases if the temperature inside the quench head 254 exceeds a certain predefined threshold (e.g., 600 degrees Fahrenheit).

Basic operation of the jet vapor system 100 will now be described. In general, fuel is injected into the jet vapor system 100 via the intake section 200 at about 5,000 psi (pounds per square inch) from an external fuel supply through the fuel intake 218. At the same time, a stoichiometric or greater (e.g., about 10 to 20 percent more) amount of air is pumped into the jet vapor system 100 at about 500 psi from an external air supply through the air intake 214. Techniques for regulating the flow of fuel and air are well known to those having ordinary skill in the art and will therefore not be described here. The air and fuel are mixed together, ignited, and burned in the combustion section 202 to produce a hot mixture of combustion gases, primarily nitrogen, carbon dioxide, and water (or superheated steam), with small amounts of nitrogen oxides and sulfur oxides (where sulfur is present in the fuel used). Note that although a stoichiometric burn is expected, those having ordinary skill in the art understand that in practice, the burn may sometimes be only “substantially” stoichiometric, meaning that there may be a small amount of unburned material (e.g., less than one percent) remaining in some cases.

The type of fuel used, in some embodiments, is crude oil or a mixture of crude oil and diesel, although diesel by itself may also be used as well as kerogen, coal powder, and other short and long chain hydrocarbon products. A small amount of water may be added to the fuel in some embodiments, for example, around two to eight percent and preferably about five percent water, to enhance the combustion and also lower the temperature of the flame 222. As mentioned earlier, jets of water 230 from the water nozzles 228 form a sort of moving cone or curtain of water around the flame 222 that helps lower the temperature of the refractory sections 242-246 (e.g., to about 3,400 degrees Fahrenheit). The jets of water 230 naturally need to be sprayed at a higher pressure than the pressure of the incoming air, preferably at about 600 psi.

When the combustion gases flow over the refractory sections 242-246, the decreasing thickness of each refractory section 242-246 reduces the pressure (hence, velocity) of the combustion gases, creating or increasing turbulence that causes the heat in the combustion gases to be more evenly distributed. The combustion gases are then funneled toward the passageway 250 where the mesh-type high temperature catalytic converter 252 converts or reduces any unwanted emissions (e.g., carbon monoxide to carbon dioxide, etc.) that may result from incomplete combustion of the fuel and air. At the passageway 250, the pressure (hence, velocity) of the combustion gases increases back up to about 500 psi due to the smaller diameter of the passageway 250.

As the combustion gases pass through the passageway 250, a sufficient amount of water is introduced (e.g., sprayed, etc.) directly onto the combustion gases from the water line 258 to produce superheated steam or vapor that reduces the temperature in the quench section 204 to about 600 to 750 degrees Fahrenheit. In some embodiments, corrosion-controlling chemicals well known to those having ordinary skill in the art may be added to the water from the water line 258 to convert the nitrogen oxides and any sulfur oxides in the combustion gases to soluble salts. The soluble salts and any earth alkali metal compounds that may be present may then be removed periodically via the drain 264. The superheated steam or vapor, nitrogen, and carbon dioxide may then be injected into a subterranean formation for recovery of highly viscous petroleum, used for cogeneration of electricity and heat, or as an energy source in other suitable applications.

As mentioned above, coal may be used as the fuel in some embodiments. The coal may be burned by itself, or it may be burned together with a liquid hydrocarbon, for example, diesel fuel. In one implementation, coal powder may be made into slurry by mixing the coal powder with the diesel fuel, then injecting the slurry mixture into the jet vapor system 100. Alternatively, coal dust may be mixed with the pressurized air and pumped into the jet vapor system 100. In either case, the combustion gases produced by burning the coal powder or dust may then be sequestered below ground by injecting the combustion gases into the subterranean formation 102 (see FIG. 1). For these coal burning implementations, the filter 266 helps to minimize any fly ash produced from the coal. This novel application of the jet vapor system 100 allows coal, which is a known source of acid rain, smog, and other pollutants, to be used as a fuel for enhanced hydrocarbon recovery, electricity and heat cogeneration, or other applications in a clean and environmentally responsible manner.

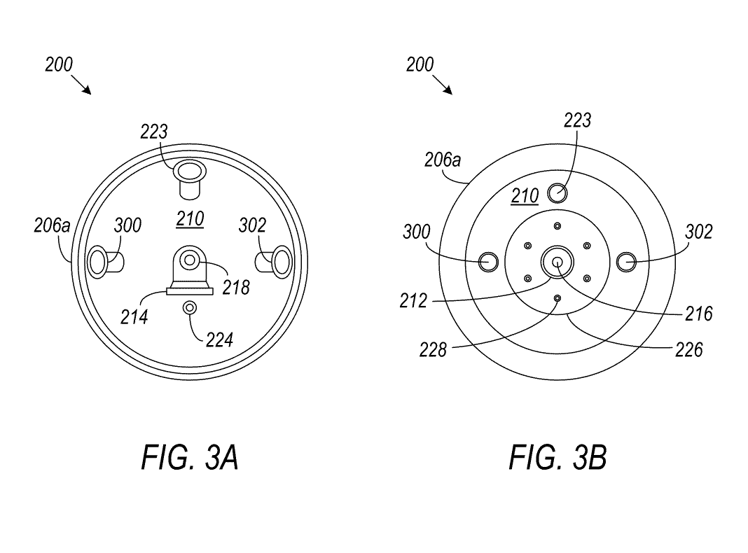

Turning now to FIGS. 3A-3B, a view of the intake section 200 from the back (FIG. 3A) and the front (FIG. 3B) ends thereof is shown. As can be seen in FIG. 3A, in addition to the previously described air intake 214, fuel intake 218, igniter port 223, and water intake 224, the intake head 210 may also have one or more additional ports provided thereon. For example, the intake head 210 may have an eye port 300 for viewing and visually examining the flame 222 in some embodiments. The eye port 300 may be similar in size, shape, and angle as the igniter port 223, or it may be different in one or more of those aspects, as deemed appropriate by those having ordinary skill in the art. Similarly, the intake head 210 may also have a flame shutdown port 302 in some embodiments for allowing an operator to manually extinguish or snuff the flame 222 as needed.

FIG. 3B shows in more detail the water nozzles 228 used for spraying the jets of water 230 that generate the cone of water around the flame 222. In one implementation, there may be six water nozzles 228 spaced evenly on the intake manifold 226 around the fuel line 216 so as to form a circular pattern having a diameter of around eight to 10 inches and preferably about nine inches. Of course, fewer or more than six nozzles may also be used depending on the particular needs of the application. The water nozzles 228 may have any size, shape, and spray pattern capable of producing a cone or curtain of water that substantially surrounds the flame 222 and is either coterminous with or extends beyond the flame 222 by a predetermined amount (e.g., six inches to one foot). As noted above, the pressure with which the water nozzles 228 spray the jets of water 230 should be greater than the pressure with which air is pumped into the jet vapor system 100 (e.g., about 600 psi).

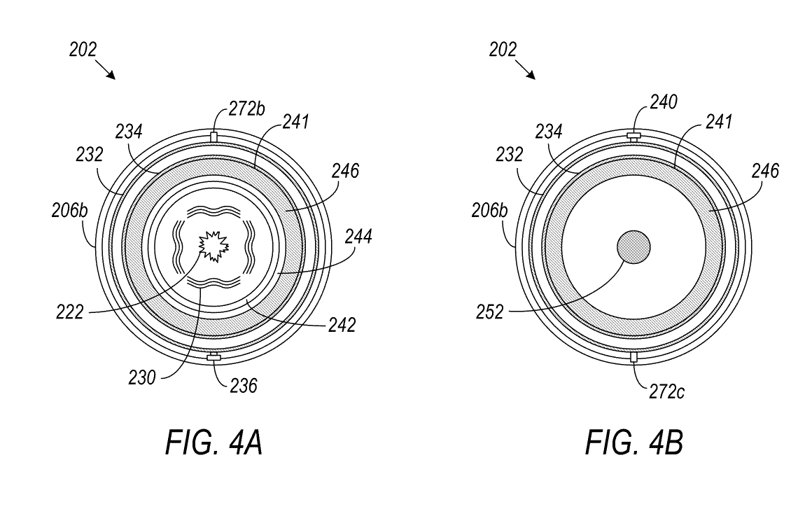

FIGS. 4A-4B are cross-sectional views of the combustion section 202 along line X-X (see FIG. 1). As can be seen here, the jets of water 230 form a sort of water cone or curtain substantially surrounding the flame 222. These jets of water 230 serve as a heat barrier to lower the temperature around the flame 222 and thereby protect the refractory 241 from becoming too hot.

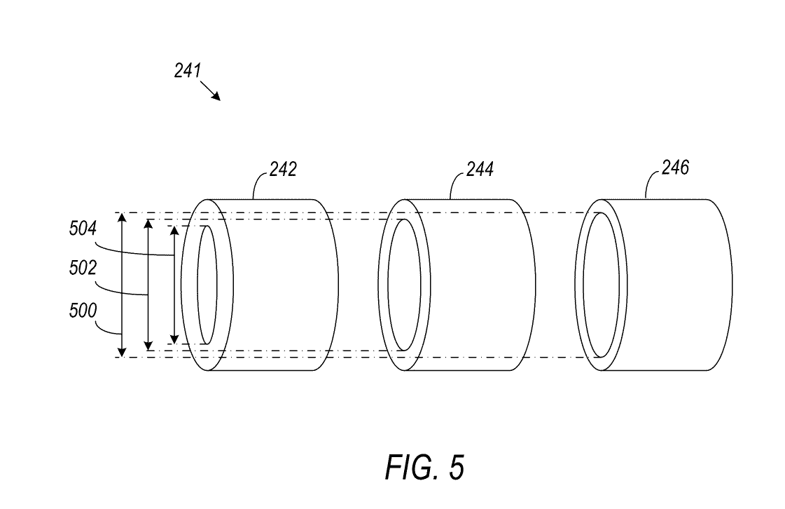

FIG. 5 illustrates a perspective view of the refractory sections 242-246 of the refractory 241. As this figure shows, the refractory sections 242-246 are generally tubular in shape and have substantially the same outer diameter, namely, around 23 to 25 inches (and preferably about 24 inches). However, each refractory section 242-246 may have a larger inner diameter (hence, smaller thickness) at the opening thereof than the preceding refractory section 242-246 (moving in the direction of flow of the combustion gases). The inner diameters are indicated in FIG. 5 by arrows 500, 502, and 504. The step-wise increases in the inner diameters 500-504 cause the pressure (hence, velocity) to decrease as the combustion gases enter each refractory section 242-246. This sudden shift in pressure creates or increases turbulence in the combustion gases, resulting in the heat becoming more evenly distributed in the combustion gases.

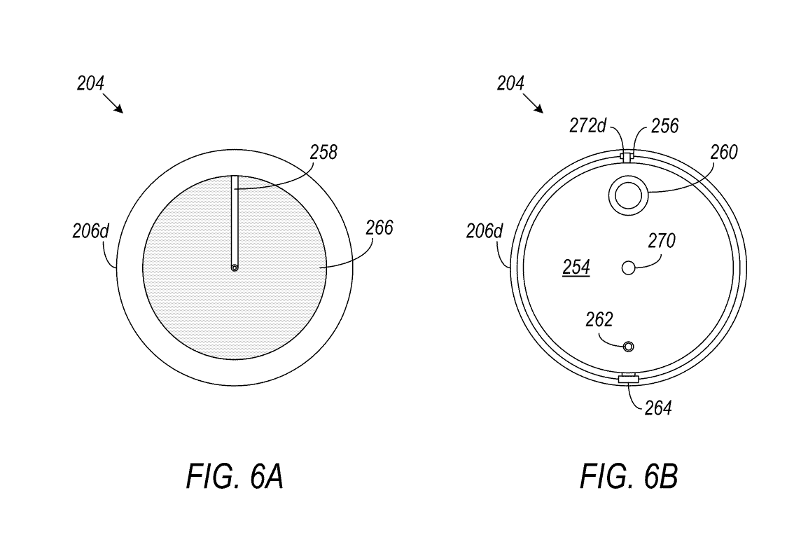

FIGS. 6A-6B show a view of the quench section 204 from the front (FIG. 6A) and from the back (FIG. 6B). In these figures, as well as in previous figures, various components, such as the quench intake 256, water line 258, vapor outlet 260, relief valve 262, drain 264, and water intake 270 have been positioned in certain locations on the quench head 254 for illustrative purposes. However, those having ordinary skill in the art will understand that other locations may also be used without departing from the scope of the disclosed embodiments. For example, instead of being located at the top of the quench head 254, the quench intake 256 (and the water line 258 extending therefrom) may be located on either side or at the bottom of the quench head 254, and so on.

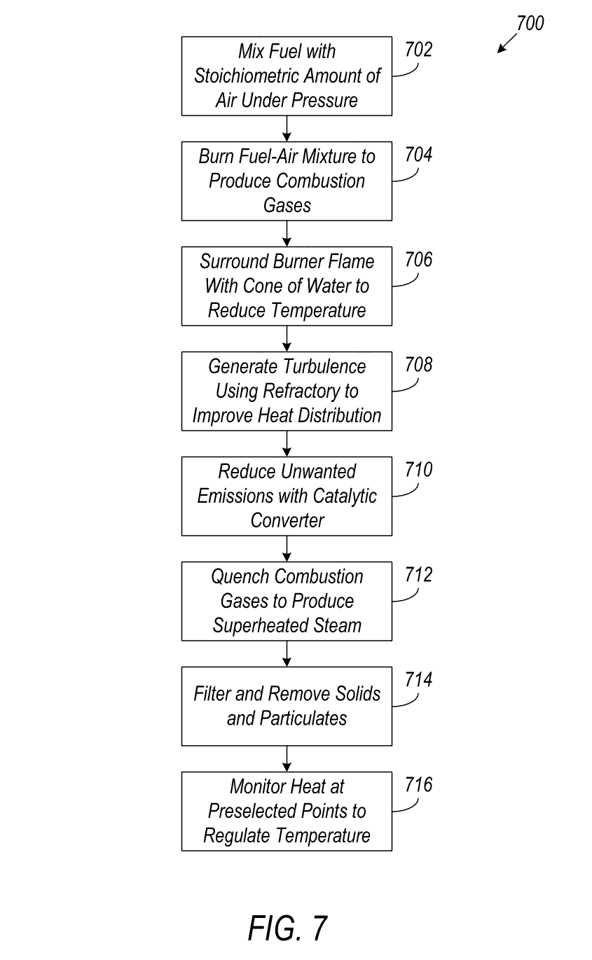

Turning now to FIG. 7, basic guidelines are shown for the operation of the jet vapor system 100 via a flow chart 700. Note that although the flowchart 700 contains a plurality of functional blocks, one or more of these blocks may be removed from the flowchart 700, and/or one or more other blocks may be added to the flowchart 700, without departing from the scope of the disclosed embodiments. In addition, one or more of the blocks may be combined with one or more other blocks, or divided into multiple smaller blocks, as needed without departing from the disclosed embodiments. Furthermore, although the blocks are displayed sequentially, those having ordinary skill in the art will recognize that one or more blocks may be taken out of sequence and/or simultaneously with one or more other blocks as needed.

The flowchart 700 begins at block 702, where a high temperature fuel, such as diesel, crude oil, diesel-crude mixture, coal powder, and other short and long chain hydrocarbon products are mixed with a stoichiometric or greater amount of air under pressure. In some embodiments, a predetermined amount of water may also be mixed in with the fuel to obtain a more complete combustion. The fuel-air mixture is then burned at block 704 to produce combustion gases, primarily nitrogen, carbon dioxide, and water. At block 706, the combustion flame is surrounded with a cone or curtain of water to reduce the temperature on the refractory of the jet vapor system 100. Turbulence may then be generated using the refractory to improve heat distribution at block 708. At block 710, unwanted emissions may be reduced (i.e., converted) using a suitable high temperature catalytic converter. The combustion gases are thereafter quenched with water at block 712 to produce superheated steam that may then be injected into a subterranean formation for heavy oil recovery or used as needed in some other applications. Solids and any other particulates may be periodically removed from the jet vapor system at block 714. Temperature at various points throughout the jet vapor system 100 may be sensed using thermocouples and the like at block 716, and appropriate control measures taken to maintain the temperature at certain predefined levels.

While the disclosed aspects of the invention have been described with reference to one or more specific implementations, those skilled in the art will recognize that many changes may be made. For example, rather than quenching the combustion gases by spraying water thereon, the water may be provided by continuously dripping or weeping the water via a perforated tank or manifold in the quench section. Accordingly, each of the foregoing embodiments and obvious variations thereof is contemplated as falling within the spirit and scope of the different aspects of the invention, which are set forth in the following claims.

What is claimed is:

1. An apparatus for generating a high pressure stream of superheated vapor, comprising:
an intake section having a plurality of water nozzles therein and configured to receive a high temperature fuel and a stoichiometric or greater amount of pressurized air for the fuel;
a combustion section adjacent to and coaxial with the intake section, the combustion section configured to house substantially stoichiometric combustion of the fuel and air to produce combustion gases; and
a quench section adjacent to and coaxial with the combustion section, the quench section having a water quench therein configured to introduce water directly onto the combustion gases to produce superheated steam;
wherein the water nozzles are configured to spray jets of water that substantially surround a flame produced by the substantially stoichiometric combustion of the fuel and air.

2. The apparatus of claim 1, wherein one or more of the plurality of water nozzles extends from the intake section into the combustion section.

3. The apparatus of claim 1, wherein the intake section includes an intake manifold configured to supply water to the plurality of water nozzles.

4. The apparatus of claim 1, wherein the combustion section includes at least one temperature sensing device, further comprising a fuel pump control unit configured to shut off the high temperature fuel to the intake section if the temperature sensing device senses a temperature above a predetermined limit.

5. The apparatus of claim 1, wherein the high temperature fuel is a short or long chain hydrocarbon product, the short or long chain hydrocarbon product including one of the following: methane, diesel, crude oil, diesel-crude mixture, kerogen, and coal powder.

6. The apparatus of claim 1, wherein the combustion section includes a substantially tubular unitary refractory.

7. The apparatus of claim 6, wherein the substantially tubular unitary refractory has a plurality of refractory sections and at least one of the plurality of refractory sections has a different thickness from at least another one of the plurality of refractory sections.

8. The apparatus of claim 6, wherein the substantially tubular unitary refractory has a plurality of refractory sections and at least one of the plurality of refractory sections is configured to funnel the combustion gases from the combustion section to the quench section.

9. An apparatus for generating a high pressure stream of superheated vapor, comprising:
an intake section configured to receive a high temperature fuel and a stoichiometric or greater amount of pressurized air for the fuel;
a combustion section adjacent to and coaxial with the intake section, the combustion section configured to house substantially stoichiometric combustion of the fuel and air to produce combustion gases; and
a quench section adjacent to and coaxial with the combustion section, the quench section having a water quench therein configured to introduce water directly onto the combustion gases to produce superheated steam;
wherein the combustion section includes a substantially tubular unitary refractory.

10. The apparatus of claim 9, wherein the substantially tubular unitary refractory has a plurality of refractory sections and at least one of the plurality of refractory sections has a different thickness from at least another one of the plurality of refractory sections.

11. The apparatus of claim 9, wherein the substantially tubular unitary refractory has a plurality of refractory sections and at least one of the plurality of refractory sections is configured to funnel the combustion gases from the combustion section to the quench section.

12. The apparatus of claim 9, wherein the combustion section includes a coolant manifold configured to circulate a coolant about the refractory.

13. The apparatus of claim 9, wherein the combustion section includes at least one temperature sensing device, further comprising a fuel pump control unit configured to shut off the high temperature fuel to the intake section if the temperature sensing device senses a temperature above a predetermined limit.

14. The apparatus of claim 9, wherein the intake section includes a plurality of water nozzles configured to spray jets of water, the jets of water substantially surrounding a flame produced by the substantially stoichiometric combustion of the fuel and air.

15. The apparatus of claim 9, further comprising a removable high temperature catalytic converter configured to convert unwanted emissions in the combustion gases before water is introduced onto the combustion gases.

16. The apparatus of claim 9, further comprising a removable filter configured to capture any fly ash in the combustion gases after water is introduced onto the combustion gases.

17. A method of generating a high pressure stream of superheated vapor, comprising:
mixing a high temperature fuel and a stoichiometric or greater amount of pressurized air to produce a mixture of fuel and air;
burning the mixture of fuel and air in a high pressure vessel to produce combustion gases;
generating turbulence in the combustion gases using a refractory in the high pressure vessel, the refractory being a unitary piece having a plurality of refractory sections;
surrounding a flame resulting from the burning of the mixture of fuel and air with a cone of water to reduce the temperature on the refractory; and
introducing water directly onto the combustion gases to produce superheated steam.

18. The method of claim 17, wherein the high pressure stream of superheated vapor is injected into a subterranean formation for recovery of heavy viscous petroleum.

19. The method of claim 17, wherein the high pressure stream of superheated vapor is provided to a turbine-electrical generator set and used for cogeneration of electricity and heat.

20. The method of claim 17, further comprising using a high temperature catalytic converter to reduce unwanted emissions in the combustion gases prior to introducing water onto the combustion gases.
